(19) United States
(12) Patent Application Publication
(10) Pub. No.: US 2025/0300468 A1
(43) Pub. Date: Sep. 25, 2025

(54) CONTROL METHOD FOR ENERGY STORAGE POWER SUPPLY, ENERGY STORAGE POWER SUPPLY, AND ENERGY STORAGE SYSTEM

(71) Applicant: SHENZHEN HELLO TECH ENERGY CO., LTD, Shenzhen (CN)

(72) Inventors: Yong LI, Shenzhen (CN); Zhongwei SUN, Shenzhen (CN); Chuzhu LIU, Shenzhen (CN)

(21) Appl. No.: 19/230,147

(22) Filed: Jun. 6, 2025

Related U.S. Application Data
(63) Continuation of application No. PCT/CN2023/117756, filed on Sep. 8, 2023.

(30) Foreign Application Priority Data
Aug. 28, 2023 (CN) 202311099042.0
Aug. 28, 2023 (CN) 202322325465.1

(51) Int. Cl. H02J 7/00; H02J 7/35

(52) U.S. Cl. CPC H02J 7/00036; H02J 7/0042; H02J 7/0047; H02J 7/00712; H02J 7/35; H02J 2300/24

(57) ABSTRACT

A control method for an energy storage power supply includes: detecting, in response to an external power supply being connected to a Type-C port, a charging type of the external power supply connected to the Type-C port, the charging type including at least one of solar charging, communication protocol charging, and vehicle charger charging; and controlling the energy storage power supply to activate a charging mode corresponding to the charging type of the external power supply, to cause the external power supply to charge a battery module of the energy storage power supply in the corresponding charging mode.

### CROSS-REFERENCE TO RELATED APPLICATIONS

This application is a continuation of International Application No. PCT/CN2023/117756, filed on Sep. 8, 2023, which claims priority and interest to Chinese Patent Application No. 202311099042.0 and Chinese Patent Application No. 202322325465.1, filed with China National Intellectual Property Administration on Aug. 28, 2023. The disclosures of the aforementioned applications are incorporated herein by reference in their entireties.

### FIELD

The present disclosure relates to the field of charging technologies, and in particular, to a control method for an energy storage power supply, an energy storage power supply, and an energy storage system.

### BACKGROUND

The use of energy storage power supplies is increasingly on the rise, and manners to charge the energy storage power supplies are increasingly diversified. Current manners for charging the energy storage power supply includes alternating current (AC) charging, communication protocol charging, solar charging, and vehicle charger charging. However, the current energy storage power supply requires charging ports for different charging manners, resulting in a larger number of charging ports of the energy storage power supply, which increases the complexity of circuit design, and increases the cost of circuit materials.

### SUMMARY

A control method for an energy storage power supply, an energy storage power supply, and an energy storage system are provided according to the present disclosure, which at least solves problems of the larger number of charging ports of the energy storage power supply, the complex circuit design, and the high cost of circuit materials.

In a first aspect, in the control method for the energy storage power supply according to embodiments of the present disclosure, the energy storage power supply includes a Type-C port configured to be electrically connected to an external power supply. The control method includes: detecting, in response to the external power supply being connected to the Type-C port, a charging type of the external power supply connected to the Type-C port, the charging type including at least one of solar charging, communication protocol charging, and vehicle charger charging; and controlling the energy storage power supply to activate a charging mode corresponding to the charging type of the external power supply, to cause the external power supply to charge a battery module of the energy storage power supply in the corresponding charging mode.

In a second aspect, the energy storage power supply according to the embodiments of the present disclosure includes: a Type-C port, a battery module, a charging type detection module electrically connected to the Type-C port, and a control module electrically connected to the charging type detection module. The Type-C port is configured to be electrically connected to an external power supply. The battery module is configured to store electrical energy supplied by the external power supply to the energy storage power supply. The charging type detection module is configured to detect, in response to the external power supply being connected to the Type-C port, a charging type of the connected external power supply. The charging type includes at least one of solar charging, communication protocol charging, and vehicle charger charging. The control module is configured to control the energy storage power supply to activate a charging mode corresponding to the charging type of the external power supply, to cause the external power supply to charge the battery module in the corresponding charging mode.

In a third aspect, the energy storage system according to the embodiments of the present disclosure includes an external power supply and an energy storage power supply. The external power supply is configured to charge the energy storage power supply. The energy storage power supply includes: a Type-C port, a battery module, a charging type detection module electrically connected to the Type-C port, and a control module electrically connected to the charging type detection module. The Type-C port is configured to be electrically connected to an external power supply. The battery module is configured to store electrical energy supplied by the external power supply to the energy storage power supply. The charging type detection module is configured to detect, in response to the external power supply being connected to the Type-C port, a charging type of the connected external power supply. The charging type includes at least one of solar charging, communication protocol charging, and vehicle charger charging. The control module is configured to control the energy storage power supply to activate a charging mode corresponding to the charging type of the external power supply, to cause the external power supply to charge the battery module in the corresponding charging mode.

The control method for the energy storage power supply, the energy storage power supply, and the energy storage system are provided according to the embodiments of the present disclosure. By providing the charging type detection module and the control module, in response to the external power supply being connected to the energy storage power supply, the energy storage power supply detects the charging type of the external power supply, and activates the corresponding charging mode, to cause the external power supply to charge the energy storage power supply. Compared to the current energy storage power supply, one Type-C port of the energy storage power supply of the present disclosure may be used in multiple charging manners, reducing the number of charging ports, reducing the complexity of circuit design, and saving the cost of circuit materials.

In a fourth aspect, the energy storage system according to the embodiments of the present disclosure includes a solar power generation module and an energy storage power supply. The solar power generation module is configured to: convert solar energy into electrical energy. The energy storage power supply includes a Type-C port, a battery module, and a control module electrically connected to the battery module. The Type-C port is configured to be electrically connected to the solar power generation module. The battery module is configured to store electrical energy supplied by the solar power generation module to the energy storage power supply. The control module is configured to control the energy storage power supply to activate a solar charging mode, to cause the solar power generation module to charge the battery module in the solar charging mode.

The energy storage system is provided according to the present disclosure. After the solar power generation module is connected to the Type-C port, the control module controls the energy storage power supply to activate the solar charging mode, to cause the solar power generation module to charge the battery module. Compared to the current energy storage power supply, the energy storage power supply of the present disclosure uses one Type-C port for the solar charging mode, without the need to provide a special solar charging interface, reducing the number of charging ports of the energy storage power supply, reducing the complexity of circuit design, and saving the cost of circuit materials.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings, in which:

FIG. 1 is a schematic flowchart of a control method for an energy storage power supply according to some embodiments of the present disclosure.

FIG. 2 is a schematic structural diagram of an energy storage power supply according to some embodiments of the present disclosure.

FIG. 3 is a schematic flowchart of a control method for an energy storage power supply according to some embodiments of the present disclosure.

FIG. 4 is a schematic flowchart of a control method for an energy storage power supply according to some embodiments of the present disclosure.

FIG. 5 is a schematic flowchart of a control method for an energy storage power supply according to some embodiments of the present disclosure.

FIG. 6 is a schematic flowchart of a control method for an energy storage power supply according to some embodiments of the present disclosure.

FIG. 7 is a schematic flowchart of a control method for an energy storage power supply according to some embodiments of the present disclosure.

FIG. 8 is a schematic flowchart of a control method for an energy storage power supply according to some embodiments of the present disclosure.

FIG. 9 is a schematic flowchart of a control method for an energy storage power supply according to some embodiments of the present disclosure.

FIG. 10 is a schematic structural diagram of an energy storage power supply according to some embodiments of the present disclosure.

FIG. 11 is a schematic diagram of a partial circuit of an energy storage power supply according to some embodiments of the present disclosure.

FIG. 12 is a schematic structural diagram of an energy storage power supply according to some embodiments of the present disclosure.

FIG. 13 is a schematic structural diagram of an energy storage power supply according to some embodiments of the present disclosure.

FIG. 14 is a schematic structural diagram of a solar power generation module according to some embodiments of the present disclosure.

FIG. 15 is a schematic diagram of a partial circuit of a solar power generation module according to some embodiments of the present disclosure.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure.

In the description of the embodiments of the present disclosure, the terms “first” and “second” are only used for descriptive purposes, and cannot be understood as indicating or implying relative importance or implicitly indicating the number of indicated technical features. Therefore, the features associated with “first” and “second” may explicitly or implicitly include at least one of the features. In the description of the embodiments of the present disclosure, “a plurality of” means two or more, unless otherwise specifically defined.

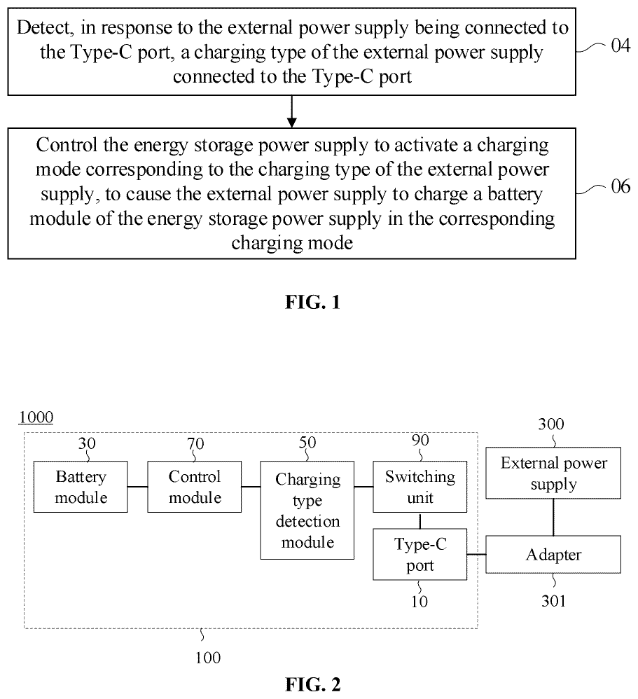

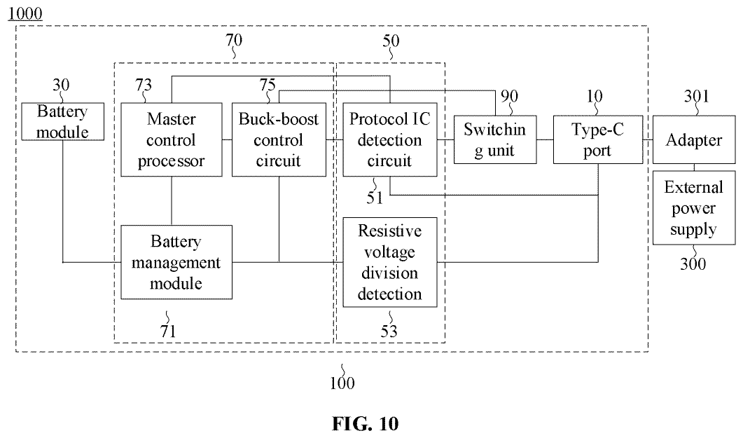

The use of energy storage power supplies is increasingly on the rise, and manners to charge the energy storage power supplies are increasing diversified. Current manners for charging the energy storage power supply includes AC charging, communication protocol charging, solar charging, and vehicle charger charging. However, the current energy storage power supply requires charging ports for different charging manners, resulting in a larger number of charging ports of the energy storage power supply, which increases the complexity of circuit design, and increases the cost of circuit materials. In order to solve this problem, a control method for an energy storage power supply (shown in FIG. 1), an energy storage power supply 100 (shown in FIG. 2 or FIG. 10), and an energy storage system 1000 (shown in FIG. 2 and FIG. 10) are provided according to the present disclosure.

Referring to FIG. 1, a control method for an energy storage power supply is provided according to an embodiment of the present disclosure. Referring to FIG. 2, the energy storage power supply 100 includes a Type-C port 10. The Type-C port 10 is configured to be electrically connected to an external power supply 300. The control method includes operations at blocks 04 and 06.

At block 04, in response to the external power supply 300 being connected to the Type-C port 10, a charging type of the external power supply 300 connected to the Type-C port 10 is detected. The charging type includes at least one of solar charging, communication protocol charging, and vehicle charger charging.

At block 06, the energy storage power supply 100 is controlled to activate a charging mode corresponding to the charging type of the external power supply 300, to cause the external power supply 300 to charge a battery module 30 of the energy storage power supply 100 in the corresponding charging mode.

Referring to FIG. 2, the energy storage power supply 100 according to an embodiment of the present disclosure includes a Type-C port 10, a battery module 30, a charging type detection module 50 electrically connected to the Type-C port 10, and a control module 70 electrically connected to the charging type detection module 50. The Type-C port 10 is configured to be electrically connected to an external power supply 300. The battery module 30 is configured to store electrical energy supplied by the external power supply 300 to the energy storage power supply 100. The charging type detection module 50 is configured to: detect, in response to the external power supply 300 being connected to the Type-C port 10, a charging type of the connected external power supply 300. The charging type includes at least one of solar charging, communication protocol charging, and vehicle charger charging. The control module 70 is configured to control the energy storage power supply 100 to activate a charging mode corresponding to the charging type of the external power supply 300, to cause the external power supply 300 to charge the battery module 30 in the corresponding charging mode.

In some embodiments, the energy storage power supply 100 is configured to store electrical energy and charge another electrical device. For example, the energy storage power supply 100 may be configured to charge devices such as a cooking device, a lighting device, or an electric vehicle. The external power supply 300 is configured to charge the energy storage power supply 100. For example, the external power supply 300 may be a solar power generation module 500 or a vehicle charging power supply.

The Type-C port 10 is disposed inside the energy storage power supply 100 and has a terminal exposed from the energy storage power supply 100. The Type-C port 10 is configured to be electrically connected to another element. When the other element is the external power supply 300, the external power supply 300 may be connected to the Type-C port 10 to charge the energy storage power supply 100. When the other element is a load, the loads may be connected to the Type-C port 10 to be charged by the energy storage power supply 100.

The battery module 30 is configured to store the electrical energy supplied by the external power supply 300 to the energy storage power supply 100. Moreover, when the energy storage power supply 100 charges another electrical device, the battery module 30 is configured to release the stored electrical energy to provide electrical energy to the other electrical device. The battery module 30 may include one or more battery cells that may be square-shaped or cylindrical batteries.

After the Type-C port 10 is electrically connected to the external power supply 300, an electrical signal from the external power supply 300 enters the charging type detection module 50 through the Type-C port 10, and the charging type of the external power supply 300 is detected by the charging type detection module 50. After the charging type detection module 50 determines the charging type of the external power supply 300, the charging type detection module 50 transmits a signal to the control module 70. The control module 70 controls the energy storage power supply 100 to activate a corresponding charging mode, to cause the charging mode of the energy storage power supply 100 to correspond to the charging type of the connected external power supply 300. Thus, the external power supply 300 can charge the energy storage power supply 100.

The charging type refers to a charging manner of the external power supply 300. The charging type of the present disclosure includes solar charging, vehicle charger charging, and communication protocol charging. In the solar charging, a solar panel may be connected to the Type-C port 10 of the energy storage power supply 100. The solar panel is configured to convert solar energy into electrical energy to charge the energy storage power supply 100. In the vehicle charger charging, a vehicle charger plug may be connected to the Type-C port 10 of the energy storage power supply 100, to cause a vehicle-mounted battery to charge the energy storage power supply 100. In the communication protocol charging, a charging agreement may be reached between the external power supply 300 and the energy storage power supply 100, to cause the external power supply 300 to charge the energy storage power supply 100. In the present disclosure, the communication protocol charging is power delivery (PD) charging that complies with a fast charging standard.

The charging modes of the energy storage power supply 100 of the present disclosure include a solar charging mode, a vehicle charger charging mode, and a communication protocol charging mode, which correspond to the solar charging, the vehicle charger charging, and the communication protocol charging, respectively. In response to the charging type of the external power supply 300 being the solar charging, the energy storage power supply 100 activates the corresponding solar charging mode, such that the external power supply 300 charges the battery module 30 of the energy storage power supply 100 in the solar charging mode. In response to the charging type of the external power supply 300 being the vehicle charger charging, the energy storage power supply 100 activates the corresponding vehicle charger charging mode, such that the external power supply 300 charges the battery module 30 of the energy storage power supply 100 in the vehicle charger charging mode. In response to the charging type of the external power supply 300 being the communication protocol charging, the energy storage power supply 100 activates the corresponding communication protocol charging mode, such that the external power supply 300 charges the battery module 30 of the energy storage power supply 100 in the communication protocol charging mode.

With the control method for the energy storage power supply and the energy storage power supply 100 according to the embodiments of the present disclosure, by providing the charging type detection module 50 and the control module 70, in response to the external power supply 300 being connected to the energy storage power supply 100, the energy storage power supply 100 detects the charging type of the external power supply 300, and activates the corresponding charging mode, to cause the external power supply 300 to charge the energy storage power supply 100. Compared to the current energy storage power supply, one Type-C port of the energy storage power supply 100 of the present disclosure may correspond to various charging modes, reducing the number of charging ports, thereby reducing the complexity of circuit design, and saving the cost of circuit materials.

Referring to FIG. 3, in some embodiments, the operation at block 04 of detecting the charging type of the external power supply 300 connected to the Type-C port 10 includes operations at blocks 041 and 043. At block 041, it is detected whether there is a communication protocol between the energy storage power supply 100 and the external power supply 300.

At block 043, it is determined that the charging type of the external power supply 300 connected to the Type-C port 10 is the communication protocol charging in response to detecting that there is a communication protocol between the energy storage power supply 100 and the external power supply 300.

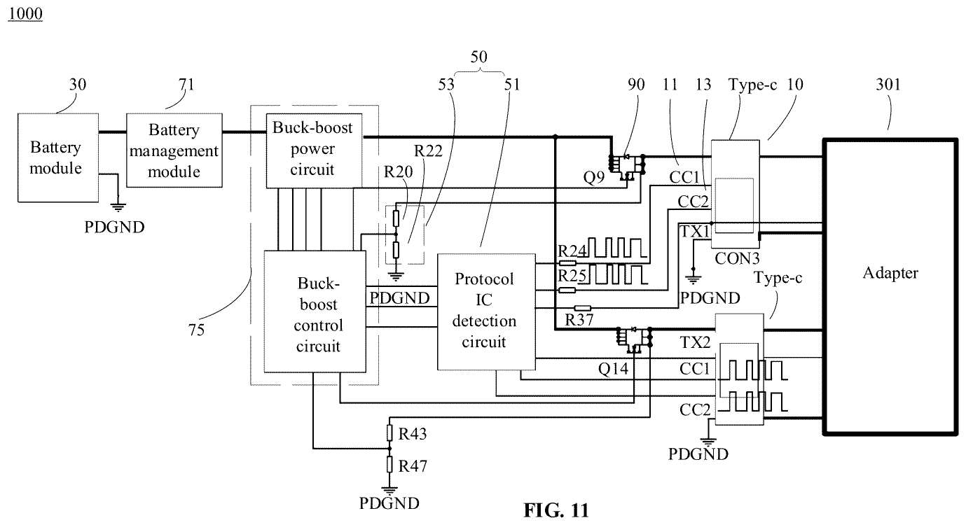

Referring to FIG. 10 and FIG. 11, in some embodiments, the charging type detection module 50 includes a protocol IC detection circuit 51. The protocol IC detection circuit 51 is in a communication connection with the Type-C port 10. The protocol IC detection circuit 51 is configured to detect whether there is a communication protocol between the energy storage power supply 100 and the external power supply 300, and determine that the charging type of the external power supply 300 connected to the Type-C port 10 is the communication protocol charging in response to detecting that there is a communication protocol between the energy storage power supply 100 and the external power supply 300.

In some embodiments, after the Type-C port 10 is electrically connected to the external power supply 300, the protocol IC detection circuit 51 is configured to identify whether there is a communication protocol between the energy storage power supply 100 and the external power supply 300. In response to identifying that there is no communication protocol between the energy storage power supply 100 and the external power supply 300, the protocol IC detection circuit 51 determines that the charging type of the external power supply 300 is not the communication protocol charging. In response to identifying that there is a communication protocol between the energy storage power supply 100 and the external power supply 300, the protocol IC detection circuit 51 determines that the charging type of the external power supply 300 is the communication protocol charging. At this time, the control module 70 controls the energy storage power supply 100 to activate the corresponding communication protocol charging mode, to cause the external power supply 300 to charge the battery module 30 of the energy storage power supply 100 in the communication protocol charging mode.

A communication protocol refers to an agreement reached between the energy storage power supply 100 and the external power supply 300 through communication and mutual negotiation. The communication protocol determines suitable power for the external power supply 300 to charge the energy storage power supply 100, realizing efficient and rapid charging between devices, and preventing damage to the devices caused by a mismatch between the external power supply 300 and the energy storage power supply 100. For example, the communication protocol specifies that the energy storage power supply 100 supports charging power of 30 W, 45 W, 60 W, and 90 W. In response to the external power supply 300 being connected to the energy storage power supply 100, when power of the external power supply 300 is greater than 90 W, after mutual communication between the external power supply 300 and the energy storage power supply 100, the external power supply 300 outputs the power of 90 W to charge the energy storage power supply 100. When the power of the external power supply 300 ranges from 45 W to 60 W (excluding 45 W and 60 W), after the mutual communication between the external power supply 300 and the energy storage power supply 100, the external power supply 300 outputs the power of 45 W to charge the energy storage power supply 100.

The communication connection between the protocol IC detection circuit 51 and the Type-C port 10 may be a wired connection or a wireless connection. In response to the wired connection between the protocol IC detection circuit 51 and the Type-C port 10, the protocol IC detection circuit 51 is connected with the Type-C port 10 through a communication wire to realize mutual communication between the protocol IC detection circuit 51 and the Type-C port 10. In this case, the communication between the protocol IC detection circuit 51 and the Type-C port 10 is isolated from external interference. In response to the wireless connection between the protocol IC detection circuit 51 and the Type-C port 10, the mutual communication between the protocol IC detection circuit 51 and the Type-C port 10 is realized through electromagnetic waves, which is more convenient.

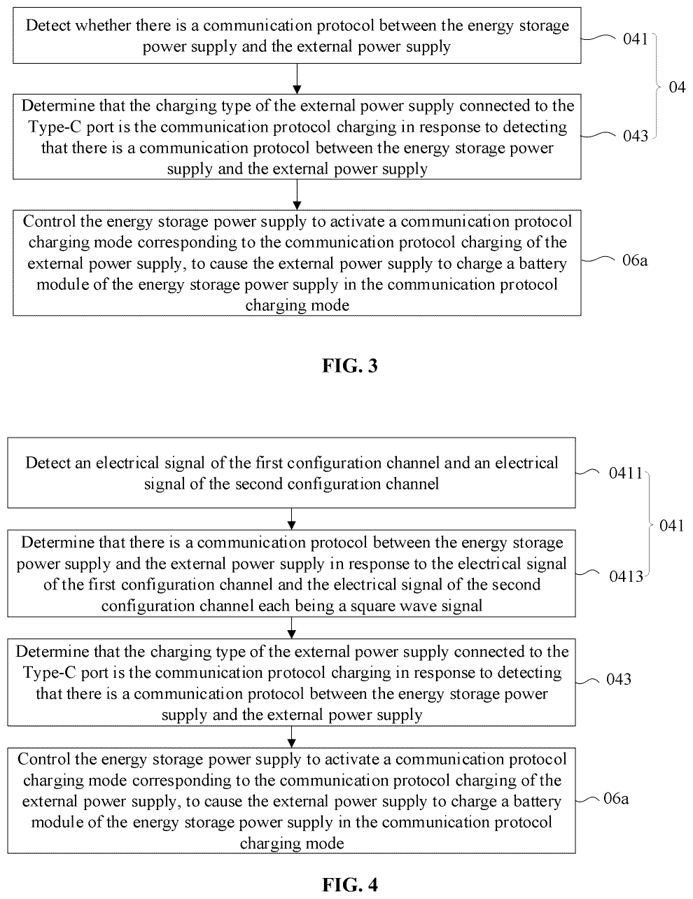

Referring to FIG. 4 and FIG. 11, in some embodiments, the protocol IC detection circuit 51 has a first terminal electrically connected to a first configuration channel (CC1) 11 of the Type-C port 10 and a second terminal electrically connected to a second configuration channel (CC2) of the Type-C port 10. The operation at block 041 of detecting whether there is a communication protocol between the energy storage power supply 100 and the external power supply 300 includes operations at blocks 0411 and 0413.

At block 0411, an electrical signal of the first configuration channel 11 and an electrical signal of the second configuration channel 13 are detected.

At block 0413, it is determined that there is a communication protocol between the energy storage power supply 100 and the external power supply 300 in response to the electrical signal of the first configuration channel 11 and the electrical signal of the second configuration channel 13 being each a square wave signal.

Referring to FIG. 11, in some embodiments, the protocol IC detection circuit 51 has a first terminal electrically connected to a first configuration channel 11 of the Type-C port 10 and a second terminal electrically connected to a second configuration channel 13 of the Type-C port 10. The protocol IC detection circuit 51 is configured to detect electrical signals of the first configuration channel 11 and the second configuration channel 13, and determine that there is a communication protocol between the energy storage power supply 100 and the external power supply 300 in response to the electrical signals of the first configuration channel 11 and the second configuration channel 13 being each a square wave signal.

In some embodiments, the first configuration channel 11 and the CC2 13 are configured to implement the mutual communication between the energy storage power supply 100 and the external power supply 300. In response to the mutual communication between the energy storage power supply 100 and the external power supply 300, each of the first configuration channel 11 and the second configuration channel 13 generates the square wave signal. Therefore, it is determined that there is a communication protocol between the energy storage power supply 100 and the external power supply 300, and the charging type of the external power supply 300 is further determined to be the communication protocol charging.

In response to the communication protocol charging between the energy storage power supply 100 and the external power supply 300, the external power supply 300 activates a communication negotiation to the energy storage power supply 100 through the first configuration channel 11 and the second configuration channel 13, i.e., informs the energy storage power supply 100 which power types are supported by the external power supply 300. Upon receiving a message through the first configuration channel 11 and the second configuration channel 13, the energy storage power supply 100 performs analysis and selects suitable power, and transmit the power to the external power supply 300. The external power supply 300 receives the message and outputs the corresponding power.

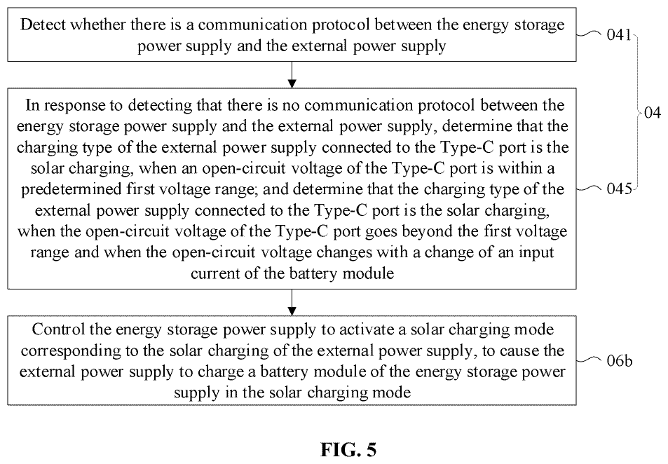

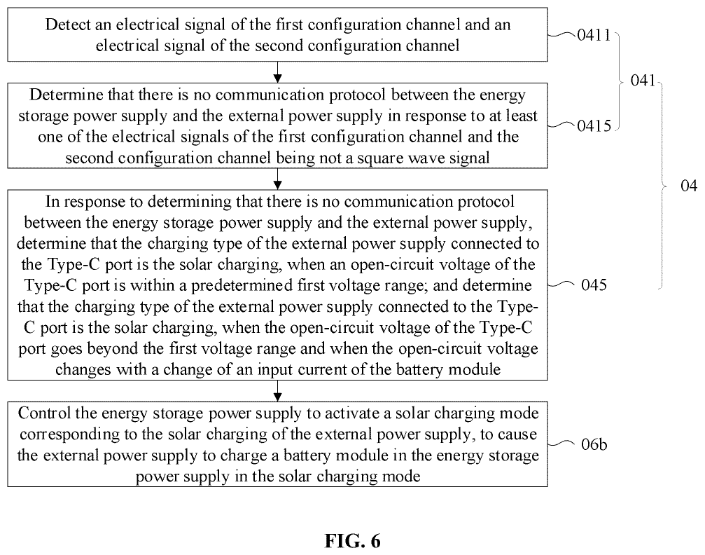

Referring to FIG. 5, in some embodiments, the operation at block 04 of detecting the charging type of the external power supply 300 connected to the Type-C port 10 includes operations at blocks 041 and 045. At block 041, it is detected whether there is a communication protocol between the energy storage power supply 100 and the external power supply 300. At block 045, in response to no communication protocol existing between the energy storage power supply 100 and the external power supply 300, it is determined that the charging type of the external power supply connected to the Type-C port is the solar charging, when an open-circuit voltage of the Type-C port 10 is within a predetermined first voltage range, and it is determined that the charging type of the external power supply 300 connected to the Type-C port 10 is the solar charging, when the open-circuit voltage of the Type-C port goes beyond the first voltage range and when the open-circuit voltage changes with a change of an input current of the battery module 30.

Referring to FIG. 10 and FIG. 11, in some embodiments, the protocol IC detection circuit 51 is further configured to determine that the charging type of the external power supply 300 connected to the Type-C port 10 is not the communication protocol charging in response to detecting that there is no communication protocol between the energy storage power supply 100 and the external power supply 300. The charging type detection module 50 further includes a resistive voltage division detection circuit 53 having a first terminal electrically connected to the Type-C port 10 and a second terminal electrically connected to the control module 70. The resistive voltage division detection circuit 53 is configured to, in response to detecting that there is no communication protocol between the energy storage power supply 100 and the external power supply 300: detect an open-circuit voltage of the Type-C port 10 and determine that the charging type of the external power supply 300 connected to the Type-C port 10 is the solar charging, when the open-circuit voltage of the Type-C port 10 is within a predetermined first voltage range, and determine that the charging type of the external power supply 300 connected to the Type-C port 10 is the solar charging, when the open-circuit voltage of the Type-C port 10 goes beyond the first voltage range and when the open-circuit voltage changes with a change of an input current of the battery module 30.

The resistive voltage division detection circuit 53 is configured to detect a voltage of a circuit, and includes two resistors connected in series. The resistive voltage division detection circuit 53 of the present disclosure includes a resistor R20 and a resistor R22 that are connected in series. The resistive voltage division detection circuit 53 is configured to detect an open-circuit voltage of the Type-C port 10 in response to determining that the charging type of the external power supply 300 is not the communication protocol charging. The predetermined first voltage range of the present disclosure is [17V, 27V]. In response to the resistive voltage division detection circuit 53 detecting that the open-circuit voltage of the Type-C port 10 is within the range of [17V, 27V], it is determined that the charging type of the external power supply 300 connected to the Type-C port 10 is the solar charging. When the open-circuit voltage of the Type-C port 10 goes beyond the first voltage range, i.e., the open-circuit voltage of the Type-C port 10 is smaller than 17V or greater than 27V, it is indicated that the charging type of the external power supply 300 connected to the Type-C port 10 may be the solar charging or may not be the solar charging. In order to further determine whether the charging type is the solar charging, the input current of the battery module 30 may be controlled to change. When the open-circuit voltage changes with the change in the input current of the battery module 30, it indicates solar charging that is likely performed on a cloudy day. For example, the control module 70 controls to increase the input current of the battery module 30. When the open-circuit voltage decreases significantly, it is determined that the charging type of the external power supply 300 connected to the Type-C port 10 is the solar charging. At this time, the control module 70 controls the energy storage power supply 100 to start the corresponding solar charging mode, to cause the external power supply 300 to charge the battery module 30 of the energy storage power supply 100 in the solar charging mode.

In addition, referring to FIG. 6, in some embodiments, the operation at block 041 of detecting whether there is an communication protocol between the energy storage power supply 100 and the external power supply 300 further includes an operation at block 0415.

At block 0415, it is determined that there is no communication protocol between the energy storage power supply 100 and the external power supply 300 in response to at least one of the electrical signals of the first configuration channel 11 and the second configuration channel 13 being not the square wave signal.

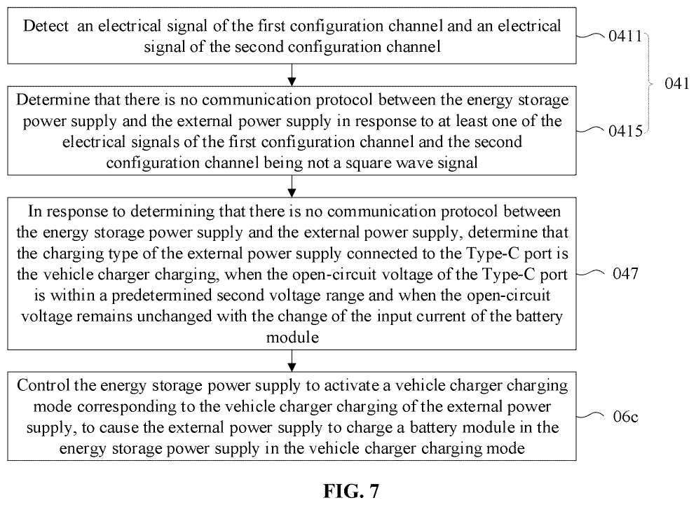

Referring to FIG. 7, in some embodiments, the operation at block 04 of detecting the charging type of the external power supply 300 connected to the Type-C port 10 includes operations at blocks 041 and 047. At block 041, it is detected whether there is a communication protocol between the energy storage power supply 100 and the external power supply 300.

At block 047, in response to detecting that there is no communication protocol between the energy storage power supply 100 and the external power supply 300, it is determined that the charging type of the external power supply 300 connected to the Type-C port 10 is the vehicle charger charging when the open-circuit voltage of the Type-C port 10 is within a predetermined second voltage range and when the open-circuit voltage remains unchanged with the change of the input current of the battery module 30.

Referring to FIG. 10 and FIG. 11, in some embodiments, the protocol IC detection circuit 51 is further configured to determine that the charging type of the external power supply 300 connected to the Type-C port 10 is not the communication protocol charging in response to detecting that there is no communication protocol between the energy storage power supply 100 and the external power supply 300. The charging type detection module 50 further includes a resistive voltage division detection circuit 53 having a first terminal electrically connected to the Type-C port 10 and a second terminal electrically connected to the control module 70. The resistive voltage division detection circuit 53 is configured to, in response to detecting that there is no communication protocol between the energy storage power supply 100 and the external power supply 300: detect the open-circuit voltage of the Type-C port 10, and determine that the charging type of the external power supply 300 connected to the Type-C port 10 is the vehicle charger charging when the open-circuit voltage of the Type-C port 10 is within a predetermined second voltage range and when the open-circuit voltage remains unchanged with the change of the input current of the battery module 30.

The second voltage range is different from the first voltage range. In other words, the second voltage range has no intersection with the first voltage range. In the present disclosure, the second voltage range is smaller than the first voltage range. The resistive voltage division detection circuit 53 of the present disclosure is configured to detect the open-circuit voltage of the Type-C port 10 in response to determining that the charging type of the external power supply 300 is not the communication protocol charging. For example, the predetermined second voltage range of the present disclosure is [10V, 17V). In response to the resistive voltage division detection circuit 53 detecting that the open-circuit voltage of the Type-C port 10 is within the range of [10V, 17V), the control module 70 controls to change the input current of the battery module 30. For example, the control module 70 controls to increase the input current of the battery module 30. When there is almost no change in the open-circuit voltage, it is determined that the charging type of the external power supply 300 connected to the Type-C port 10 is the vehicle charger charging. At this time, the control module 70 controls the energy storage power supply 100 to activate the corresponding vehicle charger charging mode, to cause the external power supply 300 to charge the battery module 30 of the energy storage power supply 100 in the vehicle charger charging mode.

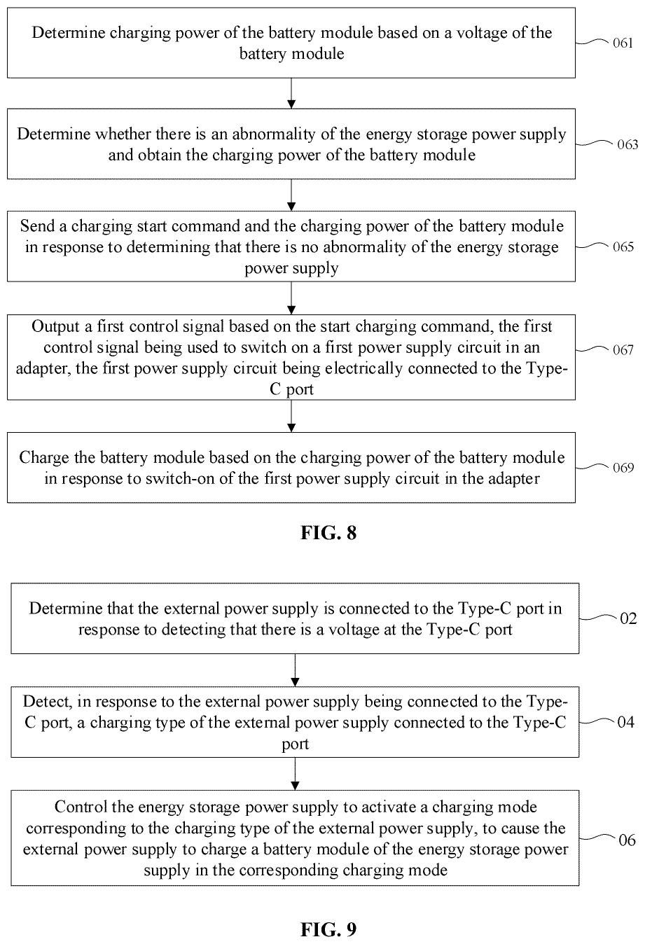

Referring to FIG. 8, in some embodiments, the operation at block 06 of controlling the energy storage power supply 100 to activate the charging mode corresponding to the charging type of the external power supply 300, to cause the external power supply 300 to charge the battery module 30 of the energy storage power supply 100 in the charging mode includes operations at blocks 061 to 069.

At block 061, charging power of the battery module 30 is determined based on a voltage of the battery module 30.

At block 063, it is determined whether there is an abnormality of the energy storage power supply 100, and the charging power of the battery module 30 is obtained.

At block 065, a charging start command and the charging power of the battery module 30 are transmitted in response to determining that there is no abnormality of the energy storage power supply 100.

At block 067, a first control signal is outputted based on the charging start command. The first control signal is used to switch on a first power supply circuit in an adapter 301. The first power supply circuit is electrically connected to the Type-C port 10.

At block 069, the battery module 30 is controlled to be charged based on the charging power of the battery module 30 in response to switch-on of the first power supply circuit in the adapter 301.

Referring to FIG. 10 and FIG. 11, in some embodiments, the control module 70 includes a battery management system 71 electrically connected to the battery module 30, a master control processor 73, and a buck-boost control circuit 75. The battery management system 71 is configured to determine charging power of the battery module 30 based on a voltage of the battery module 30. The master control processor 73 is electrically connected to the battery management system 71 and is configured to determine whether there is an abnormality of the energy storage power supply 100 and obtain the charging power of the battery module 30 from the battery management system 71. The buck-boost control circuit 75 is electrically connected to the master control processor 73 and electrically connected to the Type-C port 10 through a switching unit 90. The master control processor 73 is further configured to transmit a charging start command to the protocol IC detection circuit 51 and transmit the charging power of the battery module 30 to the buck-boost control circuit 75 in response to determining that there is no abnormality of the energy storage power supply 100. The protocol IC detection circuit 51 is further configured to output a first control signal based on the charging start command. The first control signal is used to switch on a first power supply circuit in an adapter 301. The first power supply circuit is electrically connected to the Type-C port 10. The buck-boost control circuit 75 is configured to control the switching unit 90 to be turned on upon receiving the charging power of the battery module 30, and perform voltage boosting and/or voltage bucking to charge the battery module 30 based on the charging power of the battery module 30.

In some embodiments, the Battery Management system 71 (BMS) is configured to monitor and manage the battery module 30. The battery management system 71 controls charging and discharging processes of the battery module 30 by collecting and performing calculation on parameters such as a voltage, current, and temperature. For example, the battery management system 71 determines the charging power of the battery module 30 by collecting and performing calculation on the voltage of the battery module 30.

The master control processor 73 is configured to send an instruction to control operation of other elements. In an embodiment, the master control processor 73 may be a Micro Controller Unit (MCU). In another embodiment, the master control processor 73 may be a Central Process Unit (CPU). The master control processor 73 according to the embodiments of the present disclosure adopts the MCU. The master control processor 73 communicates with the battery management system 71 and obtains a charging power signal of the battery module 30 in response to determining that there is no abnormality of the energy storage power supply 100. The abnormality of the energy storage power supply 100 includes cases of having no communication between the master control processor 73 and the BMS, having an abnormality in the communication between the master control processor 73 and the BMS, having an imbalance in a voltage of the BMS, and having an abnormality in other elements inside the energy storage power supply 100.

Subsequent to the master control processor 73 receiving the charging power signal of the battery module 30, the master control processor 73 sends the charging start command to the protocol IC detection circuit 51. The protocol IC detection circuit 51 outputs the first control signal. The adapter 301 turns on the first power supply circuit connected to the Type-C port 10 upon receiving the first control signal. The “first control signal” herein may be a high level signal or a low level signal. In an embodiment of the present disclosure, the “first control signal” is the high level signal. Further, a resistor R37 may be provided between the protocol IC detection circuit 51 and the Type-C port 10. The resistor R37 is configured to limit current and protect the Type-C port 10 when the protocol IC detection circuit 51 outputs a high level.

The master control processor 73 is further configured to transmit the charging power of the battery module 30 to the buck-boost control circuit 75. After the buck-boost control circuit 75 receives the charging power of the battery module 30 transmitted by the master control processor 73, the buck-boost control circuit 75 turns on the switching unit 90 to switch on a charging circuit of the energy storage power supply 100. Then, combined with the first power supply circuit in the adapter 301 that is switched on, the external power supply 300 may be caused to start charging the energy storage power supply 100. Meanwhile, the buck-boost control circuit 75 is configured to adapt the power transmitted from the external power supply 300 to the energy storage power supply 100 to charging power required by the battery module 30 of the energy storage power supply 100 (through boosting and/or bucking), thereby charging the battery module 30 of the energy storage power supply 100. For example, the charging power required by the battery module 30 is 30 W, and the power transmitted from the external power supply 300 to the energy storage power supply 100 is 80 W. In this case, the buck-boost control circuit 75 is configured to reduce the power of 80 W to the power of 30 W to charge the battery module 30.

In response to the charging type of the external power supply 300 connected to the Type-C port 10 being the communication protocol charging, the buck-boost control circuit 75 performs voltage boosting and/or voltage bucking according to the communication protocol charging mode corresponding to the communication protocol charging, to cause the external power supply 300 to charge the battery module 30 of the energy storage power supply 100 in the communication protocol charging mode.

In response to the charging type of the external power supply 300 connected to the Type-C port 10 is the solar charging, a Maximum Power Point Tracking (MPPT) unit in the buck-boost control circuit 75 is capable of detecting a power generation voltage of the solar panel in real time and tracking a maximum voltage and current, to cause the external power supply 300 to output the electrical energy at maximum power. Meanwhile, the buck-boost control circuit 75 also performs voltage boosting and/or voltage bucking based on the solar charging mode corresponding to the solar charging, to cause the external power supply 300 to charge the battery module 30 of the energy storage power supply 100 in the solar charging mode. It should be noted that the MPPT unit may be integrated within the buck-boost control circuit 75 or be provided separately independent of the buck-boost control circuit 75, which is not limited herein.

In response to the charging type of the external power supply connected to the Type-C port 10 is the vehicle charger charging, the buck-boost control circuit 75 performs voltage boosting and/or voltage bucking based on the vehicle charger charging mode corresponding to the vehicle charger charging, to cause the external power supply 300 to charge the battery module 30 of the energy storage power supply 100 in the vehicle charger charging mode.

The switching unit 90 is configured to switch off or switch on a circuit. In response to the master control processor 73 identifying that the external power supply 300 is capable of charging the energy storage power supply 100, the buck-boost control circuit 75 controls the switching unit 90 to be turned on to switch on the charging circuit. In response to the master control processor 73 identifying that the external power supply 300 is uncapable of charging the energy storage power supply 100, the buck-boost control circuit 75 controls the switching unit 90 to be turned off, to turn off the charging circuit. The switching unit 90 may be a transistor or a Metal-Oxide-Semiconductor (MOS). The switching unit 90 being the transistor has a low cost, and the switching unit 90 being the MOS is capable of acting as a power switch of a high-current circuit.

Referring to FIG. 9, in some embodiments, the control method includes an operation at block 02.

At block 02, it is determined that the external power supply 300 is connected to the Type-C port 10 in response to detecting that there is a voltage at the Type-C port 10.

In conjunction with FIG. 10 and FIG. 11, in some embodiments, the resistive voltage division detection circuit 53 is configured to determine that the external power supply 300 is connected to the Type-C port 10 in response to detecting that there is a voltage at the Type-C port 10.

In response to determining that the external power supply 300 is connected to the Type-C port 10, the charging type detection module 50 starts to detect the charging type of the external power supply 300, while the control module 70 starts to control the energy storage power supply 100 to start the corresponding charging mode, so that the external power supply 300 charges the energy storage power supply 100.

Referring to FIG. 10, an energy storage system 1000 according to an embodiment of the present disclosure includes an external power supply 300 and the energy storage power supply 100 according to any of the above embodiments. The external power supply 300 is configured to charge the energy storage power supply 100. The external power supply 300 may be a solar power generation module 500, a vehicle charging power supply, other power supply devices capable of charging via PD, or the like.

The energy storage system 1000 is provided according to the embodiments of the present disclosure. By providing the charging type detection module 50 and the control module 70, in response to the external power supply 300 being connected to the energy storage power supply 100, the energy storage power supply 100 detects the charging type of the external power supply 300, so that the energy storage power supply 100 is capable of activating the corresponding charging mode, to cause the external power supply 300 to charge the energy storage power supply 100. Compared to the current energy storage power supply, one Type-C port 10 in the energy storage power supply 100 of the present disclosure may correspond to multiple charging modes, reducing the number of charging ports, reducing the complexity of circuit design, and saving the cost of circuit materials.

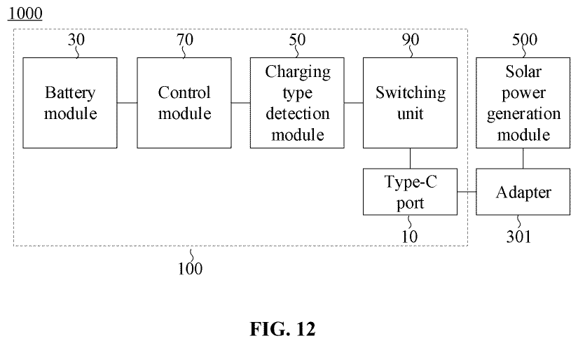

Referring to FIG. 12, the energy storage system 1000 according to an embodiment of the present disclosure includes a solar power generation module 500 and an energy storage power supply 100. The solar power generation module 500 is configured to convert solar energy into electrical energy. The energy storage power supply 100 includes a Type-C port 10, a battery module 30, and a control module 70 electrically connected to the battery module 30. The Type-C port 10 is configured to be electrically connected to the solar power generation module 500. The battery module 30 is configured to store electrical energy supplied by the solar power generation module 500 to the energy storage power supply 100. The control module 70 is configured to control the energy storage power supply 100 to activate a solar charging mode, to cause the solar power generation module 500 to charge the battery module 30 in the solar charging mode.

In some embodiments, the energy storage power supply 100 is configured to store electrical energy and charge another electrical device. For example, the energy storage power supply 100 may be configured to charge devices such as a cooking device, a lighting device, or an electric vehicle. The Type-C port 10 is disposed inside the energy storage power supply 100 and has a terminal exposed from the energy storage power supply 100. The Type-C port 10 is configured to be electrically connected to another element. When the other element is the external power supply 300, the external power supply 300 may be connected to the Type-C port 10 to charge the energy storage power supply 100. When the other element is a load, the load may be connected to the Type-C port 10 to be charged by the energy storage power supply 100. The battery module 30 is configured to store the electrical energy supplied by the solar power generation module 500 to the energy storage power supply 100. Moreover, when the energy storage power supply 100 charges another electrical device. The battery module 30 is configured to release the stored electrical energy to provide electrical energy to the other electrical device. The battery module 30 may include one or more battery cells that may be square-shaped or cylindrical batteries.

Upon receiving a signal that the Type-C port 10 is electrically connected to the solar power generation module 500, the control module 70 controls the energy storage power supply 100 to activate the solar charging mode, so that the solar power generation module 500 can charge the energy storage power supply 100.

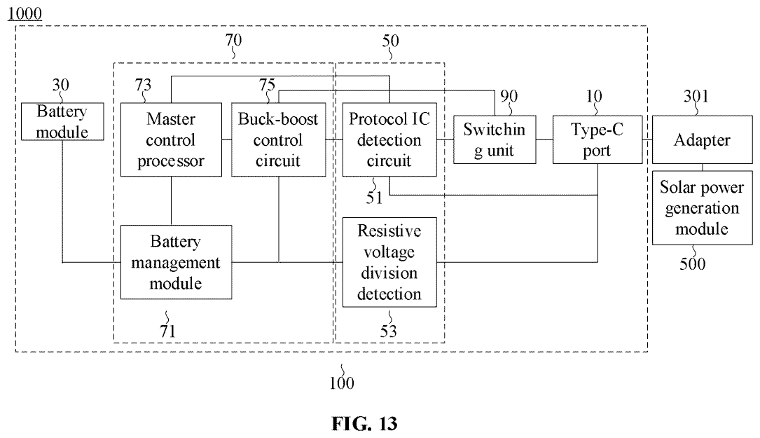

Referring to FIG. 12 and FIG. 13, in some embodiments, the energy storage power supply 100 further includes a charging type detection module 50 electrically connected to the Type-C port 10. The charging type detection module 50 is configured to: detect, in response to the external power supply being connected to the Type-C port 10, a charging type of the connected external power supply. The control module 70 is electrically connected to the charging type detection module 50. The control module 70 is configured to control the energy storage power supply to activate a solar charging mode in response to the charging type detection module 50 detecting that the charging type of the external power supply is solar charging, to cause the solar power generation module 500 to charge the battery module 30 in the solar charging mode. In some embodiments, after the Type-C port 10 is electrically connected to the external power supply, an electrical signal from the external power supply enters the charging type detection module 50 through the Type-C port 10, and the charging type of that external power supply is detected by the charging type detection module 50. In response to the charging type detection module 50 determining that the external power supply is the solar power generation module 500, the charging type detection module 50 transmits the signal to the control module 70, and the control module 70 controls the energy storage power supply 100 to activate the solar charging mode, so that the solar power generation module 500 can charge the energy storage power supply 100.

The energy storage power supply 100 of this embodiment is completely the same as the energy storage power supply 100 in the above-described embodiments and explained as before, and details are omitted here.

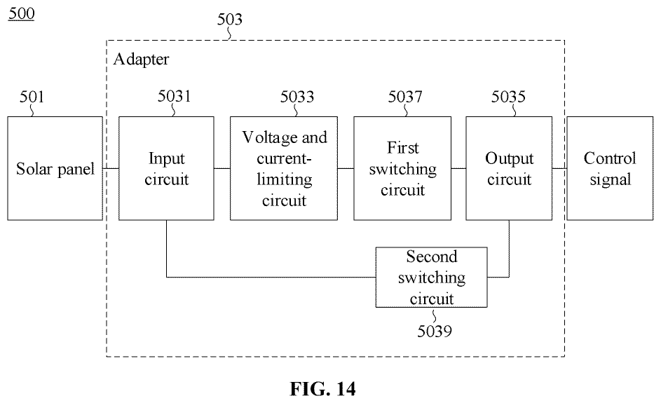

Referring to FIG. 14, in some embodiments, the solar power generation module 500 includes a solar panel 501 and an adapter 503. The adapter 503 includes an input circuit 5031, a voltage and current-limiting circuit 5033, an output circuit 5035, a first switching circuit 5037, and a second switching circuit 5039. The input circuit 5031 is configured to: receive electrical energy from the solar panel 501. The voltage and current-limiting circuit 5033 is configured to convert the electrical energy received from the solar panel 501 into current output of a pre-determined voltage. The output circuit 5035 is electrically connected to the Type-C port, and is further configured to receive an externally transmitted control signal. The first switching circuit 5037 is configured to initiate or stop current output from the voltage and current-limiting circuit 5031 to the output circuit 5035 based on the control signal. The second switching circuit 5039 is configured to initiate or stop current output from the input circuit 5031 to the output circuit 5035 based on the control signal.

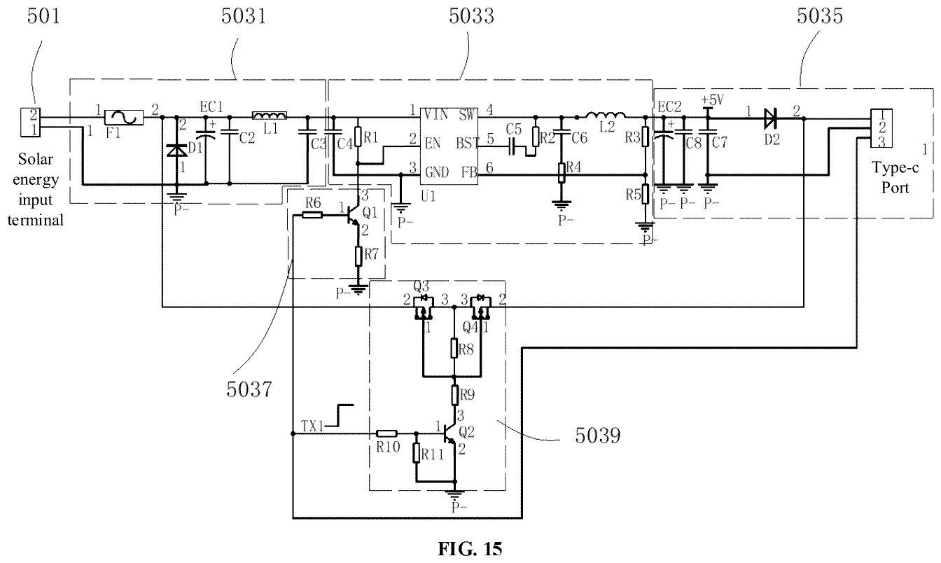

Referring to FIG. 14 and FIG. 15, in some embodiments, the control signal includes a first control signal transmitted by the control module to the output circuit 5035 through the Type-C port. In response to the output circuit 5035 receiving the first control signal, the current output from the voltage and current-limiting circuit 5033 to the output circuit 5035 is stopped by the first switching circuit 5037, and the current output from the input circuit 5031 to the output circuit 5035 is initiated by the second switching circuit 5039. In response to the output circuit 5035 receiving the first control signal, a first power supply circuit of the adapter 503 is switched on, to cause the solar panel 501 to charge the energy storage power supply 100. The first power supply circuit includes the input circuit 5031, the second switching circuit 5039, and the output circuit 5035. In response to the second switching circuit 5039 turning on the input circuit 5031 and the output circuit 5035, the solar panel 501 is capable of outputting a high current through the adapter 503 to charge the energy storage power supply 100, thereby rapidly charging the energy storage power supply 100 at high power.

Referring to FIG. 14 and FIG. 15, in some embodiments, the control signal includes a second control signal sent by an electronic device through the Type-C port to the output circuit 5035. In response to the output circuit 5035 receiving the second control signal, the current output from the voltage and current-limiting circuit 5033 to the output circuit 5035 is initiated by the first switching circuit 5037, and the current output from the input circuit 5031 to the output circuit 5035 is stopped by the second switching circuit 5039.

The second control signal herein may be a low level signal or a high level signal. In an embodiment of the present disclosure, the second control signal is the low level signal. The first control signal and the second control signal of the present disclosure are different. The electronic device herein may be a product chargeable by using low-power, such as a mobile phone, a computer, a PAD, or an earphone. When the second control signal is received by the adapter 503, a second power supply circuit inside the adapter 503 is switched on, to output a relatively low current to charge the electronic device. The second power supply circuit includes the input circuit 5031, the voltage and current-limiting circuit 5033, the first switching circuit 5037, and the output circuit 5035. In response to the adapter 503 being electrically connected to an electronic device requiring low-power charging, the electronic device transmits the second control signal to the output circuit 5035 through the Type-C port. In response to the output circuit 5035 receiving the second control signal, the first switching circuit 5037 initiates the current output from the voltage and current-limiting circuit 5033 to the output circuit 5035, and the second switching circuit 5039 stops the current output from the input circuit 5031 to the output circuit 5035, i.e., the first power supply circuit is turned off, and the second power supply circuit is switched on to charge the electronic device. In this way, different control signals control different power supply circuits to supply power to an external device, with high adaptability. On the one hand, charging efficiency of the energy storage power supply requiring high-power charging can be satisfied. On the other hand, damage caused by impact of the high current on the electronic device requiring low-power charging can be avoided.

In some embodiments, referring to FIG. 14 and FIG. 15, in some embodiments, the input circuit 5031 includes: a fuse F1, a first capacitor EC1, a second capacitor C2, a third capacitor C3, a first diode D1, and a first inductor L1. The fuse F1 and the first inductor L1 are connected in series to a power line. A first terminal of the fuse F1 is connected to the solar panel 501. The first diode D1 has a first terminal grounded and a second terminal connected between a second terminal of the fuse F1 and a first terminal of the first inductor L1. The first capacitor EC1 has a first terminal grounded and a second terminal connected between the second terminal of the fuse F1 and the first terminal of the first inductor L1. The second capacitor C2 has a first terminal grounded and a second terminal connected between the second terminal of the fuse F1 and the first terminal of the first inductor L1. The third capacitor C3 has a first terminal grounded and a second terminal connected to a second terminal of the first inductor L1. The first diode D1 is a voltage stabilizing diode that stabilizes the voltage in the circuit. The fuse F1 can play a certain protective role in the circuit.

Referring to FIG. 14 and FIG. 15, in some embodiments, the voltage and current-limiting circuit 5033 includes: a chip U1, a fourth capacitor C4, a fifth capacitor C5, a sixth capacitor C6, a first resistor R1, a second resistor R2, a third resistor R3, a fourth resistor R4, a fifth resistor R5, and a second inductor L2. A first terminal of the chip U1 is connected to the second terminal of the first inductor L1, a second terminal of the chip U1 is connected between the second terminal of the first inductor L1 and the first terminal of the chip U1 through the first resistor R1, a third terminal of the chip U1 is grounded, a fourth terminal of the chip U1 is connected to a first terminal of the second inductor L2, a fifth terminal of the chip U1 is connected between the fourth terminal of the chip U1 and the first terminal of the second inductor L2 through the fifth capacitor C5 and the second resistor R2, and a sixth terminal of the chip U1 is grounded through the fifth resistorR5. The fourth capacitor C4 has a first terminal connected between the second terminal of the first inductor L1 and the first terminal of the chip U1, and a second terminal connected to the third terminal of the chip U1. The sixth capacitor C6 has a first terminal connected between the fourth terminal of the chip U1 and the first terminal of the second inductor L2, and a second terminal grounded through the fourth resistor R4. The third resistor R3 has a first terminal connected to a second terminal of the second inductor L2, and a second terminal connected between the fifth resistor R5 and the sixth terminal of the chip U1.

Continuing to refer to FIG. 14 and FIG. 15, in some embodiments, the output circuit 5035 includes an output port, a second diode D2, a seventh capacitor C7, an eighth capacitor C8, and a ninth capacitor EC2. The ninth capacitor EC2 has a first terminal connected between the second inductor L2 and the third resistor R3, and a second terminal grounded. The eighth capacitor C8 has a first terminal connected between the second inductor L2 and the third resistor R3, and a second terminal grounded. The seventh capacitor C7 has a first terminal connected between the second inductor L2 and the third resistor R3, and a second terminal grounded. The second diode D2 has a first terminal connected to the first terminal of the seventh capacitor C7, and a second terminal connected to a first terminal of the output port. A second terminal of the output port is grounded. The second diode D2 can prevent a current backflow that damages the chip U1.

Referring to FIG. 14 and FIG. 15, in some embodiments, the first switching circuit 5037 includes a sixth resistor R6, a seventh resistor R7, and a first transistor Q1. The sixth resistor R6 has a first terminal connected to a third terminal of the output port, and a second terminal connected to a first terminal of the first transistor Q1. The seventh resistor R7 has a first terminal connected to a second terminal of the first transistor Q1, and a second terminal grounded. The first transistor Q1 has a third terminal connected between the first resistor R1 and the second terminal of the chip U1.

Referring to FIG. 14 and FIG. 15, in some embodiments, the second switching circuit 5039 includes an eighth resistor R8, a ninth resistor R9, a tenth resistor R10, an eleventh resistor R11, a second transistor Q2, a first field-effect transistor Q3, and a second field-effect transistor Q4. The tenth resistor R10 has a first terminal connected between the sixth resistor R6 and the third terminal of the output port, and a second terminal connected to a first terminal of the second transistor Q2. The eleventh resistor R11 has a first terminal connected between the second terminal of the tenth resistor R10 and the first terminal of the second transistor Q2, and a second terminal grounded. The first field-effect transistor Q3 and the second field-effect transistor Q4 are connected in series between the second terminal of the fuse F1 and the first terminal of the output port. The first field-effect transistor Q3 has a second terminal connected between the second terminal of the fuse and the first terminal of the first inductor L1, and a third terminal connected to a third terminal of the second field-effect transistor Q4. A second terminal of the second field-effect transistor Q4 is connected between the first terminal of the output port and the second terminal of the second diode D2. A third terminal of the second transistor Q2 is connected between the third terminal of the first field-effect transistor Q3 and a third terminal of the second field-effect transistor Q4 through the ninth resistor R9 and the eighth resistor R8 that are connected in series. A first terminal of the first field-effect transistor Q3 is connected between the ninth resistor R9 and the eighth resistor R8. A first terminal of the second field-effect transistor Q4 is connected between the ninth resistor R9 and the eighth resistor R8.

With the energy storage system 1000 of the present disclosure, in response to the solar power generation module being connected to the Type-C port 10, the control module 70 controls the energy storage power supply 100 to activate the solar charging mode, to cause the solar power generation module 500 to charge the battery module 30. Compared to the current energy storage power supply, the energy storage power supply 100 of the present disclosure uses one Type-C port 10 to correspond to the solar charging mode, without the need to provide a special solar charging interface, reducing the number of charging ports of the energy storage power supply 100, reducing the complexity of circuit design, and saving the cost of circuit materials.

The technical features of the above embodiments can be combined arbitrarily. In order to make the description simple, not every possible combination of the technical features in the above embodiments are described. However, as long as there is no conflict between the combinations of the technical features, any combination of the technical features should be considered as falling in the scope of this specification. Meanwhile, other implementations can be derived from the above-described embodiments, so that structural and logical substitutions and changes can be made without departing from the scope of the present disclosure.

The above embodiments illustrate merely some implementations of the present disclosure. Although description of the above embodiments is specific and detailed, the description should not be construed as limitations on the scope of the present disclosure. It should be pointed out that, various modifications and improvements can be made by those skilled in the art without departing from the concept of the embodiments of the present disclosure, and shall fall within the protection scope of the embodiments of the present disclosure as defined by the claims as attached.

What is claimed is:

1. A control method for an energy storage power supply, wherein the energy storage power supply comprises a Type-C port configured to be electrically connected to an external power supply, the control method comprising:
detecting, in response to the external power supply being connected to the Type-C port, a charging type of the external power supply connected to the Type-C port, the charging type comprising at least one of solar charging, communication protocol charging, and vehicle charger charging; and
controlling the energy storage power supply to activate a charging mode corresponding to the charging type of the external power supply, to cause the external power supply to charge a battery module of the energy storage power supply in the corresponding charging mode.

2. The control method according to claim 1, wherein said detecting the charging type of the external power supply connected to the Type-C port comprises:
detecting whether there is a communication protocol between the energy storage power supply and the external power supply; and
determining that the charging type of the external power supply connected to the Type-C port is the communication protocol charging, in response to detecting that there is a communication protocol between the energy storage power supply and the external power supply.

3. The control method according to claim 2, wherein the energy storage power supply comprises a protocol IC detection circuit, the protocol IC detection circuit having a first terminal electrically connected to a first configuration channel of the Type-C port and a second terminal electrically connected to a second configuration channel of the Type-C port; and
wherein said detecting whether there is a communication protocol between the energy storage power supply and the external power supply comprises:
detecting an electrical signal of the first configuration channel and an electrical signal of the second configuration channel; and
determining that there is a communication protocol between the energy storage power supply and the external power supply, in response to the electrical signal of the first configuration channel and the electrical signal of the second configuration channel being each a square wave signal.

4. The control method according to claim 1, wherein said detecting the charging type of the external power supply connected to the Type-C port comprises:
detecting whether there is a communication protocol between the energy storage power supply and the external power supply; and
in response to detecting that there is no communication protocol between the energy storage power supply and the external power supply,
determining that the charging type of the external power supply connected to the Type-C port is the solar charging, when an open-circuit voltage of the Type-C port is within a predetermined first voltage range;
determining that the charging type of the external power supply connected to the Type-C port is the solar charging, when the open-circuit voltage of the Type-C port goes beyond the first voltage range and when the open-circuit voltage changes with a change of an input current of the battery module; or
determining that the charging type of the external power supply connected to the Type-C port is the vehicle charger charging, when the open-circuit voltage of the Type-C port is within a predetermined second voltage range and when the open-circuit voltage remains unchanged with the change of the input current of the battery module.

5. The control method according to claim 1, wherein said controlling the energy storage power supply to active the charging mode corresponding to the charging type of the external power supply, to cause the external power supply to charge the battery module of the energy storage power supply in the corresponding charging mode comprises:
determining charging power of the battery module based on a voltage of the battery module;
determining whether there is an abnormality of the energy storage power supply and obtaining the charging power of the battery module;
transmitting, in response to determining that there is no abnormality of the energy storage power supply, a charging start command and the charging power of the battery module;
outputting a first control signal based on the charging start command, the first control signal being used to switch on a first power supply circuit in an adapter, the first power supply circuit being electrically connected to the Type-C port; and
charging, in response to switch-on of the first power supply circuit in the adapter, the battery module based on the charging power of the battery module.

6. The control method according to claim 1, comprising:
determining, in response to detecting that there is a voltage at the Type-C port, that the external power supply is connected to the Type-C port.

7. An energy storage power supply, comprising:
a Type-C port configured to be electrically connected to an external power supply;
a battery module configured to store electrical energy supplied by the external power supply to the energy storage power supply;
a charging type detection module electrically connected to the Type-C port, the charging type detection module being configured to detect, in response to the external power supply being connected to the Type-C port, a charging type of the connected external power supply, the charging type comprising at least one of solar charging, communication protocol charging, and vehicle charger charging; and
a control module electrically connected to the charging type detection module, the control module being configured to control the energy storage power supply to activate a charging mode corresponding to the charging type of the external power supply, to cause the external power supply to charge the battery module in the corresponding charging mode.

8. The energy storage power supply according to claim 7, wherein the charging type detection module comprises:
a protocol IC detection circuit in a communication connection with the Type-C port, the protocol IC detection circuit being configured to: detect whether there is a communication protocol between the energy storage power supply and the external power supply; and determine that the charging type of the external power supply connected to the Type-C port is the communication protocol charging, in response to detecting that there is a communication protocol between the energy storage power supply and the external power supply.

9. The energy storage power supply according to claim 8, wherein the protocol IC detection circuit has a first terminal electrically connected to a first configuration channel of the Type-C port and a second terminal electrically connected to a second configuration channel of the Type-C port; and
wherein the protocol IC detection circuit is configured to:
detect an electrical signal of the first configuration channel and an electrical signal of the second configuration channel; and
determine that there is a communication protocol between the energy storage power supply and the external power supply, in response to the electrical signal of the first configuration channel and the electrical signal of the second configuration channel being each a square wave signal.

10. The energy storage power supply according to claim 8, wherein the protocol IC detection circuit is further configured to determine that the charging type of the external power supply connected to the Type-C port is not the communication protocol charging, in response to detecting that there is no communication protocol between the energy storage power supply and the external power supply; and
the charging type detection module further comprises:
a resistive voltage division detection circuit having a first terminal electrically connected to the Type-C port and a second terminal electrically connected to the control module, the resistive voltage division detection circuit being configured to, in response to detecting that there is no communication protocol between the energy storage power supply and the external power supply:
detect an open-circuit voltage of the Type-C port; and
determine that the charging type of the external power supply connected to the Type-C port is the solar charging, when the open-circuit voltage of the Type-C port is within a predetermined first voltage range; or
determine that the charging type of the external power supply connected to the Type-C port is the solar charging, when the open-circuit voltage of the Type-C port goes beyond the first voltage range and when the open-circuit voltage changes with a change of an input current of the battery module; or
determine that the charging type of the external power supply connected to the Type-C port is the vehicle charger charging, when the open-circuit voltage of the Type-C port is within a predetermined second voltage range and when the open-circuit voltage remains unchanged with the change of the input current of the battery module.

11. The energy storage power supply according to claim 10, wherein the resistive voltage division detection circuit is further configured to determine, in response to detecting that there is a voltage at the Type-C port, that the external power supply is connected to the Type-C port.

12. The energy storage power supply according to claim 8, wherein the control module comprises:
a battery management module electrically connected to the battery module, the battery management module being configured to determine charging power of the battery module based on a voltage of the battery module;
a master control processor electrically connected to the battery management module, the master control processor being configured to determine whether there is an abnormality of the energy storage power supply and obtain the charging power of the battery module from the battery management module; and
a buck-boost control circuit electrically connected to the master control processor and electrically connected to the Type-C port through a switching unit, the master control processor being further configured to, in response to determining that there is no abnormality of the energy storage power supply, transmit a charging start command to the protocol IC detection circuit and transmit the charging power of the battery module to the buck-boost control circuit,
wherein the protocol IC detection circuit is further configured to output a first control signal based on the charging start command, the first control signal being used to switch on a first power supply circuit in an adapter, the first power supply circuit being electrically connected to the Type-C port; and
the buck-boost control circuit is configured to control the switching unit to be switched on upon receiving the charging power of the battery module, and charge the battery module based on the charging power of the battery module.

13. An energy storage system, comprising:
an external power supply; and
the energy storage power supply according to claim 7, the external power supply being configured to charge the energy storage power supply.

14. The energy storage system according to claim 13, wherein:
the external power supply is a solar power generation module configured to convert solar energy into electrical energy; and
the control module is configured to control the energy storage power supply to activate the solar charging mode, in response to detecting by the charging type detection module that the charging type of the external power supply is the solar charging, to cause the solar power generation module to charge the battery module in the solar charging mode.

15. The energy storage system according to claim 13, wherein the charging type detection module comprises:
a protocol IC detection circuit in communication connection with the Type-C port, the protocol IC detection circuit being configured to: detect whether there is a communication protocol between the energy storage power supply and the external power supply; and determine, in response to detecting that there is no communication protocol existing between the energy storage power supply and the external power supply, that the charging type of the external power supply connected to the Type-C port is not the communication protocol charging; and
a resistive voltage division detection circuit having a first terminal electrically connected to the Type-C port and a second terminal electrically connected to the control module, wherein the resistive voltage division detection circuit is configured to, in response to detecting that there is no communication protocol between the energy storage power supply and the external power supply:
detect an open-circuit voltage of the Type-C port; and
determine that the charging type of the external power supply connected to the Type-C port is the solar charging, when the open-circuit voltage of the Type-C port is within a predetermined first voltage range; or
determine that the charging type of the external power supply connected to the Type-C port is the solar charging, when the open-circuit voltage of the Type-C port goes beyond the first voltage range and when the open-circuit voltage changes with a change of an input current of the battery module.

16. The energy storage system according to claim 15, wherein the protocol IC detection circuit has a first terminal electrically connected to a first configuration channel of the Type-C port and a second terminal electrically connected to a second configuration channel of the Type-C port; and
wherein the protocol IC detection circuit is configured to:
detect an electrical signal of the first configuration channel and an electrical signal of the second configuration channel; and
determine that there is no communication protocol between the energy storage power supply and the external power supply, in response to at least one of the electrical signal of the first configuration channel and the electrical signal of the second configuration channel being not a square wave signal.

17. The energy storage system according to claim 15, wherein the resistive voltage division detection circuit is further configured to determine, in response to detecting that there is a voltage at the Type-C port, that the external power supply is connected to the Type-C port.

18. The energy storage system according to claim 15, wherein the control module comprises:
a battery management module electrically connected to the battery module, the battery management module being configured to determine charging power of the battery module based on a voltage of the battery module;
a master control processor electrically connected to the battery management module, the master control processor being configured to determine whether there is an abnormality of the energy storage power supply and obtain the charging power of the battery module from the battery management module; and
a buck-boost control circuit electrically connected to the master control processor and electrically connected to the Type-C port through a switching unit, the master control processor being further configured to, in response to determining that there is no abnormality of the energy storage power supply, transmit a charging start command to the protocol IC detection circuit and transmit the charging power of the battery module to the buck-boost control circuit,
wherein the protocol IC detection circuit is further configured to output a first control signal based on the charging start command, the first control signal being used to switch on a first power supply circuit in an adapter, the first power supply circuit being electrically connected to the Type-C port; and
wherein the buck-boost control circuit is configured to: control the switching unit to be switched on upon receiving the charging power of the battery module, track maximum power of the external power supply, and charge the battery module based on the charging power of the battery module and the maximum power of the external power supply.

19. The energy storage system according to claim 14, wherein the solar power generation module comprises a solar panel and an adapter, the adapter comprising:
an input circuit configured to receive electrical energy from the solar panel;
a voltage- and current-limiting circuit configured to convert the electrical energy received from the solar panel into current output of a predetermined voltage;
an output circuit electrically connected to the Type-C port, the output circuit being configured to receive an externally transmitted control signal;
a first switching circuit configured to initiate or stop current output from the voltage- and current-limiting circuit to the output circuit based on the control signal; and
a second switching circuit configured to initiate or stop current output from the input circuit to the output circuit based on the control signal.

20. The energy storage system according to claim 19, wherein:
the control signal comprises a first control signal sent by the control module to the output circuit through the Type-C port, wherein in response to the output circuit receiving the first control signal, the current output from the voltage- and current-limiting circuit to the output circuit is stopped by the first switching circuit, and the current output from the input circuit to the output circuit is initiated by the second switching circuit; or
the control signal comprises a second control signal sent by an electronic device to the output circuit through the Type-C port, wherein in response to the output circuit receiving the second control signal, the current output from the voltage- and current-limiting circuit to the output circuit is initiated by the first switching circuit, and the current output from the input circuit to the output circuit is stopped by the second switching circuit.
